(19) United States
(12) Patent Application Publication
(10) Pub. No.: US 2025/0378266 A1
(43) Pub. Date: Dec. 11, 2025

(54) MACHINE-LEARNING MODEL FOR TRAINING DATA GENERATION

(71) Applicant: SAP SE, Walldorf (DE)

(72) Inventor: Chinmay Kakatkar, Munich (DE)

(21) Appl. No.: 18/735,456

(22) Filed: Jun. 6, 2024

(51) Int. Cl. G06F 40/174

(52) U.S. Cl. CPC G06F 40/174

(57) ABSTRACT

Methods, systems, and apparatus, including medium-encoded computer program products for training a model to perform tabular data imputation include: obtaining initial tabular training data for imputing data for a tabular data object defined for a user interface form of an application, wherein the initial tabular training data includes rows of data collected from entries for the user interface form; generating noisy tabular training data by invoking a second model trained over the initial tabular training data, wherein generating noisy tabular training data comprises up-sampling the initial tabular training data according to learned application-specific masking rules defined as part of the second model, the application-specific masking rules being generated for the user interface form of the application; and training a first model by inputting the generated noisy tabular training data as a predictor and by applying denoising techniques to output predicted field values for fields of the user interface form.

### BACKGROUND

The present disclosure relates to computer-implemented methods, software, and systems for data processing.

### BACKGROUND

Software applications can provide services and access resources. Software applications can provide services to end user and expose interfaces that allow for user interaction and data input. Software applications can store obtained data from users, for example, in tabular format at data stores. Tabular data can be organized in rows and columns, where each row can represent a record of data associated with a data object such as an entity, an order, an executed task, etc. Each column in tabular data can represent a specific attribute, property or variable related to the record.

### SUMMARY

The present disclosure describes mechanisms to implement a method for training a machine learning model to perform tabular data imputation that can be used to automatically input data during a user interaction for filling in data in a form. The concept of denoising of noisy data created based on real data generated for data objects created through a user interface form can be used to construct and train the machine learning model as a tabular data imputer.

In a first aspect, the subject matter described in this specification can be embodied in one or more methods (and also one or more non-transitory computer-readable mediums tangibly encoding a computer program operable to cause data processing apparatus to perform operations), including: receiving first input data from a user, the first input data including a first field value for a first field on a user interface form provided on a user interface at a display device; in response to receiving the first input data, invoking a trained model for tabular data imputation to predict values for one or more other user interface fields of the user interface form based on the first field value for the first field; providing one or more predicted field data values for the one or more other user interface fields on the user interface form based on an output of the trained model as recommendations for the user; receiving second input data from the user including a second field value for a second field of the one or more other user interface fields, wherein the second input data is confirming or modifying a respective predicted field data value for the second field; in response to receiving the second field value from the user, automatically invoking the trained model to predict a third field value for a third field of the user interface form based on the received first field value for the first field and the received second field value for the second field; and providing the third field value for the third field on the user interface form in addition to previously-provided predicted or confirmed field data values for fields of the user interface form.

In a second aspect, the subject matter described in this specification can be embodied in one or more methods (and also one or more non-transitory computer-readable mediums tangibly encoding a computer program operable to cause data processing apparatus to perform operations), including: obtaining initial tabular training data for imputing data for a tabular data object defined for a user interface form of an application, wherein the initial tabular training data includes rows of data collected from entries for the user interface form submitted by users of the application; generating noisy tabular training data by invoking a second model trained over the initial tabular training data, wherein generating noisy tabular training data includes up-sampling the initial tabular training data according to learned application-specific masking rules defined as part of the second model, the application-specific masking rules being generated for the user interface form of the application; and training a first model by inputting the generated noisy tabular training data as a predictor and by applying denoising techniques to output predicted field values for fields of the user interface form.

The described subject matter can be implemented using a computer-implemented method; a non-transitory, computer-readable medium storing computer-readable instructions to perform the computer-implemented method; and a computer-implemented system including one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, in accordance with implementations of the present disclosure, data imputation can be performed flexibly and in an automated manner to auto-fill values in fields on user interface forms. Second, the data imputation can generally be performed more accurately compared to data imputation of previous approaches that do not rely on machine learning algorithms according to the present techniques. Third, the provided techniques and tools for filling in data into user interface form support faster execution that is less computationally expensive than other approaches (e.g., generative AI, large language models) while also being sufficiently accurate. Fourth, the present techniques support interoperability with various tools or services for managing user interface forms and extensibility to adjust to different functionality supported and provided by such other tools. As such, the provided methods and systems are easy to maintain and integrate within other existing systems so that the data imputation can be tuned to other environment and data contexts.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 depicts an example architecture 100 in accordance with implementations of the present disclosure.

FIG. 2A is a flowchart illustrating an example of a computer-implemented method for imputing tabular data based on a trained model, according to an implementation of the present disclosure.

FIG. 2B is a flow chart illustrating an example of a computer-implemented method for training a model to perform tabular data imputation, according to an implementation of the present disclosure.

FIG. 3A is a block diagram illustrating an example user interface form provided for user interaction and input of field values at one or more fields, according to an implementation of the present disclosure.

FIG. 3B is a block diagram illustrating an example user interface form provided for user interaction that implements logic for automatic data imputation based on a trained model, according to an implementation of the present disclosure.

FIG. 4A is a block diagram illustrating an example user interface form provided for user interaction and modification of a field value provided as a recommendation to a field in the user interface form by invoking a trained model, according to an implementation of the present disclosure.

FIG. 4B is a block diagram illustrating an example user interface form updated with one or more recommendations for one or more fields of the user interface form based on received user input to modify a previously recommended field value of the user interface form, according to an implementation of the present disclosure.

FIG. 4C is a block diagram illustrating an example user interface form updated with one or more recommendations for one or more fields of the user interface form based on received user input to modify a previously recommended field value of the user interface form, according to an implementation of the present disclosure.

FIG. 5 is a block diagram illustrating an example method 500 for training a model for tabular data imputation based on denoising techniques, according to an implementation of the present disclosure.

FIG. 6 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes mechanisms to implement a method for training a machine learning model to perform tabular data imputation that can be used to automatically input data during a user interaction for filling in data in a form.

Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Filling in data in user interface forms provided by applications can be a time-consuming task that is error prone. Possible inaccuracies in the data recording or issues upon execution of requests in view of data discrepancy can lead to inefficiency in process and task executions.

Filling in a form can be performed in the context of a human-computer interaction, where a user provides input data to perform steps of a procedure that requires input and relies on implemented logic for guiding the user in executing the procedure and providing the relevant data as recommendation to automate the process. To support a user in the tasks of filling in a user interface form, an intelligent inference system can be created that understands specifics of the application and the use of the user interface form so that the user can be provided with recommendation for values to be filled in the user interface form for fields that have not been provided with field values by the user or otherwise (e.g., based on fixed rules).

User interface forms can be associated with storing data in tabular form, and based on such stored tabular data, an inference can be made for recommending field values to be provided for fields where values are missing in accordance with implementations of the present disclosure. If missing values, not yet filled in a user interface form that is initiated to be filled in by a user, cannot be ignored or omitted, for example, based on rules defined for the user interface form defining these values as required, these values can be imputed so that missing values in forms can be filled in with other values, such as recommended values by a trained machine learning model. While missing values can be imputed based on approaches such as filling in missing values with a constant (default) value or using a most commonly used value or an average value in a dataset, such approaches may be associated with a higher rate of inaccuracy compared to intelligent approaches based on machine learning models that are trained on particular application data and/or user style of interactions. Such machine learning approaches are more accurate and can be executed based on efficient utilization of resources by training a model according to training data that supports accurate training results without undue use of resources for performing exhausting training that can be computationally expensive (e.g., having higher hardware requirements) and time consuming.

In accordance with implementations of the present disclose, a method for automatically creating data to be filled in user interface forms to support automatic generation of data objects (e.g., business objects such as sales orders, purchase orders, etc.; or technical data objects such as master data, configuration data, etc.) is needed. In some instances, a method for leveraging the concept of denoising of noisy data created based on real data generated for data objects created through a user interface form can be used to construct (or train) a machine learning model that can be used as a tabular data imputer. In some instances, a model can be trained to reconstruct an original (or clean) copy of training data (e.g., data collected from historically generated objects through the user interface form and/or otherwise) based on a noisy copy of the same training data.

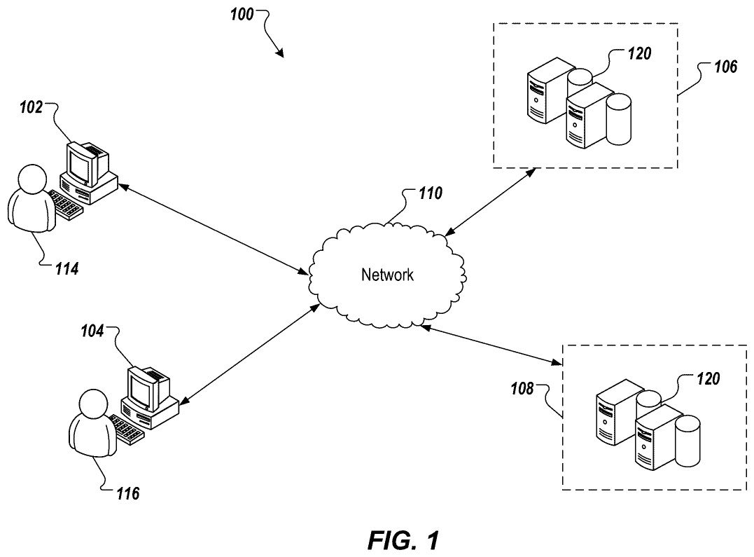

FIG. 1 depicts an example architecture 100 in accordance with implementations of the present disclosure. In the depicted example, the example architecture 100 includes a client device 102, a client device 104, a network 110, an environment 106, and an environment 108. The environment 106 and the environment 108 may be cloud environments. The environment 106 and the environment 108 may include corresponding one or more server devices and databases (e.g., processors, memory). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the environment 106 includes at least one server and at least one data store 120. In the example of FIG. 1, the environment 106 is intended to represent various forms of servers including, but not limited to a web server, an application server, a proxy server, a network server, and/or a server pool. In general, server systems accept requests for application services and provides such services to any number of client devices (e.g., the client device 102 over the network 110) and other service requests, as appropriate.

In some instances, the environments 106 and 108 may host one or more client applications that can provide user interfaces including user interface form that implement machine learning techniques described in the present application to support automatic data imputation. The machine learning techniques used to generate the tabular data imputer can further rely on a trained model to generate training data that can be used for a training process that is more efficient since the process can utilizing a smaller amount of data (aligned with a particular domain for the data imputation) that is associated with fewer costs for the data maintenance and the training execution, while still providing accurate recommendations or predictions for the data imputation.

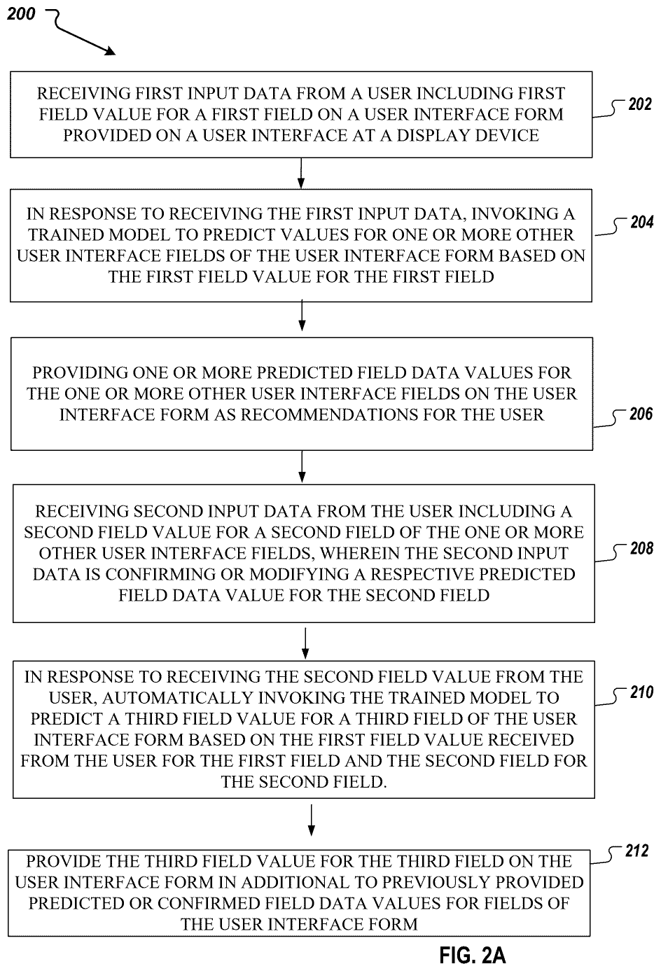

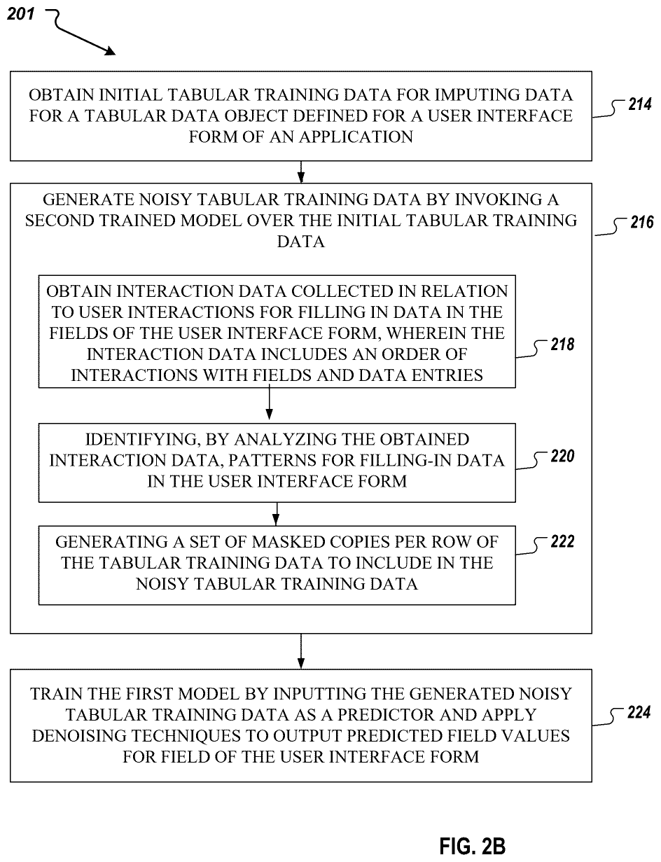

FIG. 2A is a flowchart illustrating an example of a computer-implemented method 200 for imputing tabular data based on a trained model, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

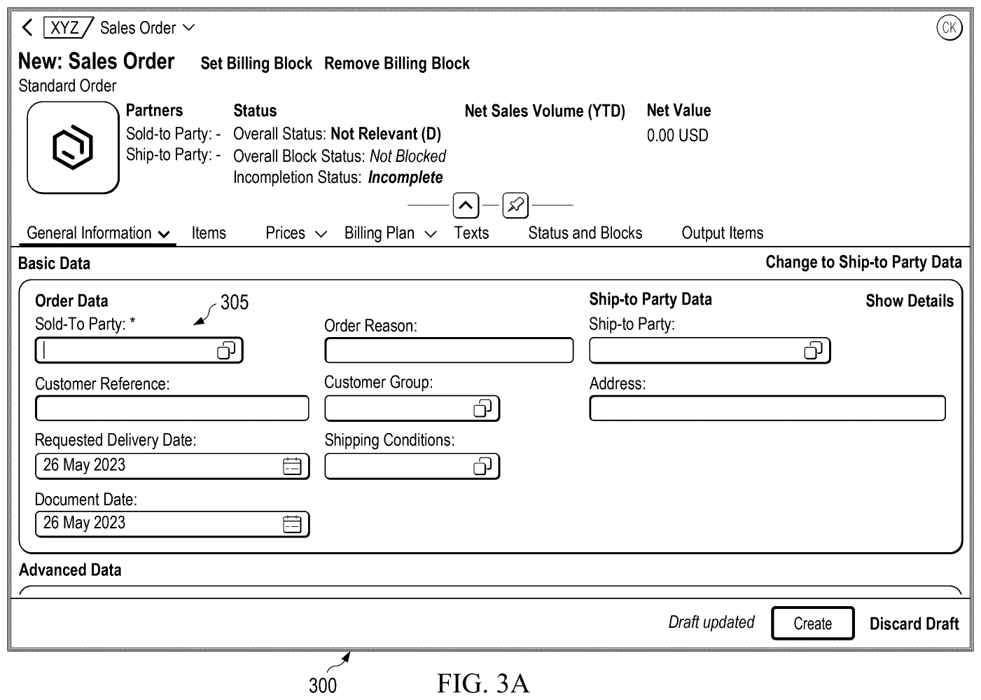

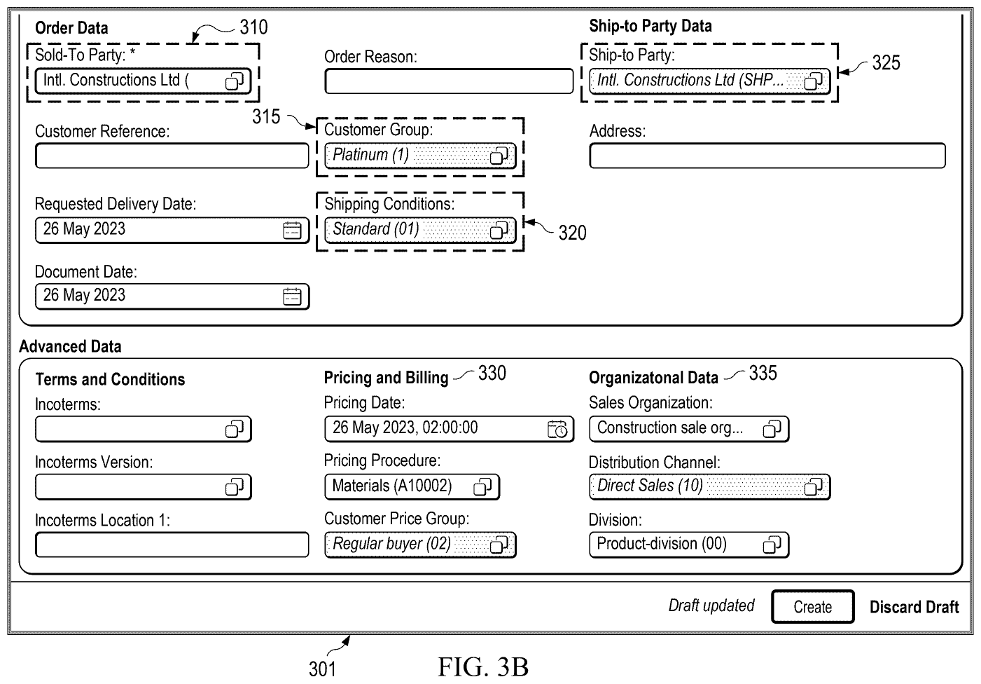

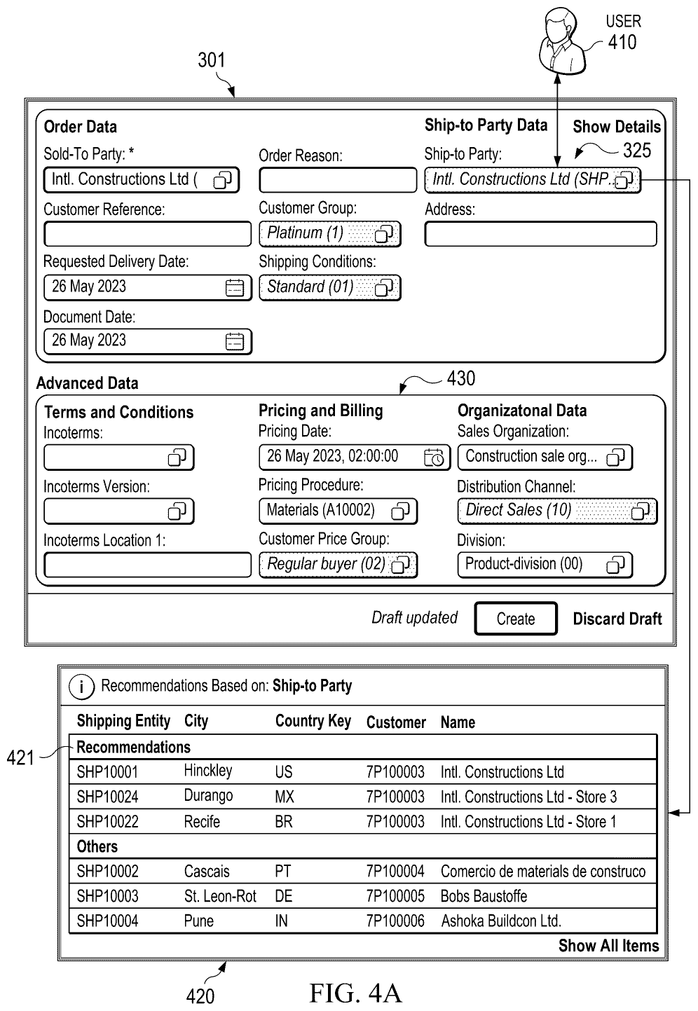

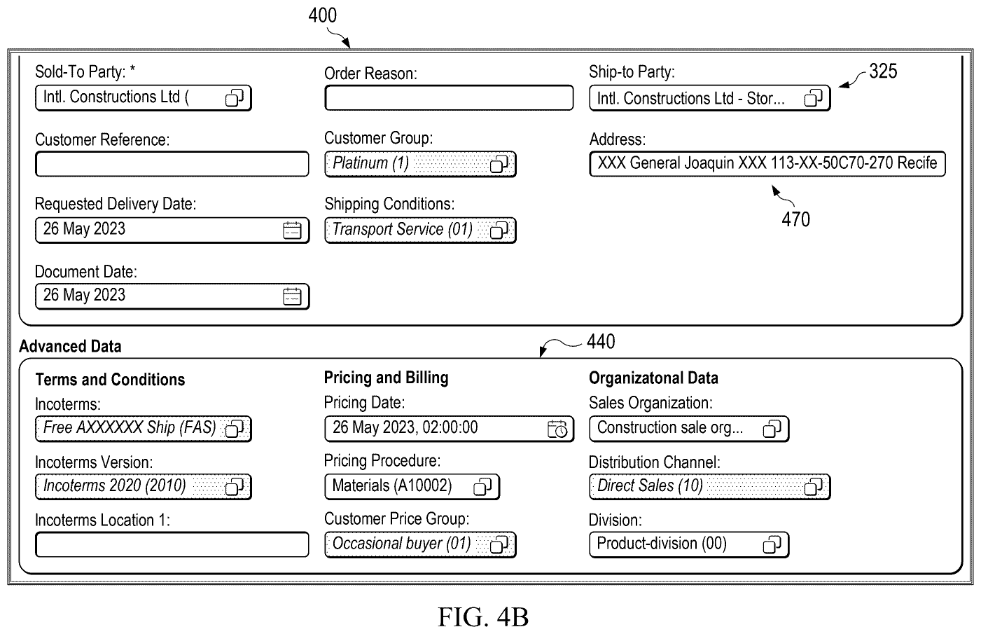

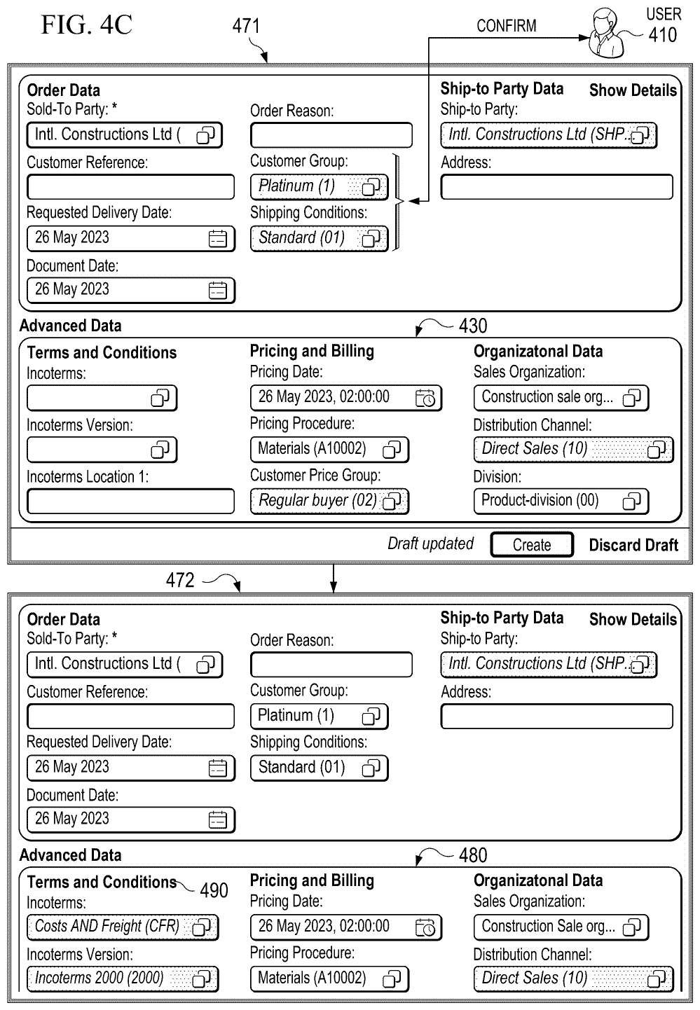

In some instances, the interaction between a user and a user interface form as described in relation to method 200 can be performed in the context of filling in a user interface form as shown and described in relation to FIGS. 3A, 3B, 4A, 4B, and 4C.

At 202, first input data is received from a user including a first field value for a first field on a user interface form provided on a user interface at a display device.

At 204, in response to the received first input data, a trained model is invoked to predict values for one or more other user interface fields of the user interface form based on the first field value for the first field. The trained model is a model for tabular data imputation.

At 206, one or more predicted field data values for the one or more other user interface fields on the user interface form are provided as recommendations for the user. The one or more predicted field data values can be provided within the user interface form, for example, can be marked or highlighted as “smart” suggestions for filling in data in the user interface form that are provided automatically to the user for confirmation or modification.

At 208, second input data is received from the user. The second input data includes a second field value for a second field of the one or more other user interface fields. The second input data can be for confirming or modifying a respective predicted field data value for the second field.

At 210, in response to receiving the second field value from the user, the trained model is automatically invoked to predict a third field value for a third field of the user interface form based on the first field value received from the user for the first field and the second field for the second field.

At 212, providing the third field value for the third field on the user interface form in additional to previously provided predicted or confirmed field data values for fields of the user interface form. In this way, the user interface form is iteratively populated based on data provided by the user and other data that is input by the trained model. The data input by the trained model can be considered as a “proposal” from the trained model to fill in some fields of the user interface form that are not yet populated by data values by the user based on an intelligent prediction system for inferring the values.

In some instances, the trained model predicts the data for the third field of the user interface (at 210) form only based on the received first and second input data from the user without using other field data values from the provided one or more predicted field data values as recommendations for the user interface form. In some instances, the trained model can be trained based on denoising techniques applied to noisy tabular training data, wherein the noisy tabular training data is generated for a tabular data object stored at a storage associated with the user interface by using a second trained model, therein the tabular data object includes data objects corresponding to user interface fields of the user interface form. In some instances, the trained model can be trained as described in relation to FIG. 2B.

In some instances, input is provided to the user interface form, such as input for field values for fields in the user interface form or confirmation of recommended values, and the input is used to update a tabular data object stored for the user interface form. The tabular data object can be stored in a storage (e.g., database, server, etc.) that is associated with the user interface form. For example, the user interface form can be part of a user interface of an application for storing data related to data objects. For example, the application can be a logistic application storing data for requested or performed transportations of good, an inventory application storing data for assets or goods of an organization, a sales managing application storing data for business objects such as enterprises, products, orders, sales, advertisement, etc.

In some instances, the user interface form can be considered as a tool for obtaining data that is stored in a tabular data object can be a table (e.g., a database table) at a storage associated with the tool. Different fields of the user interface form can be associated with different properties stored at the table (e.g., properties defined in columns for the table). In some cases, one row of a table is a record associated with a single user interface form and provided input for fields of the user interface form, for example, based on an interactive process of inputting data by a user and executing a completion of the user interface form by the user.

In some instances, in response to the first field value for the first field (as received at 202) and the second field value for the second field from the user (as received at 208), a tabular data object stored for the user interface form can be updated by updating a first data object and a second data object to store data according to the first field value and the second field value, wherein the first data object corresponds to the first field and the second data object corresponds to the second field.

In some instances, fourth input data can be received by the user that include a fourth field value for a fourth field of the user interface form. The fourth input data can be received after receiving the first and second input data for the first and second fields, and after providing the third field value for the third field of the user interface. The first, second and third fields can be considered as different fields in the user interface form. The fourth field can be different from the first and second fields. In response to receiving the fourth input data, the trained model can be automatically invoked (e.g., configured to be invoked upon receipt of user input at the user interface form) to predict data for at least one other field of the user interface form based on the first field value, the second field value, and the fourth field value. In such way, the user interface form can be iteratively populated with data in a fast yet accurate manner. In accordance with the implementations of the present disclosure, the performed data imputation method is extensible and generalizable to accommodate different number of fields, and the four field values mentioned here are for the sake of the example. The data imputation can be performed for any number of fields and combination thereof.

FIG. 2B is a flow chart illustrating an example of a computer-implemented method for training a model to perform tabular data imputation, according to an implementation of the present disclosure. For clarity of presentation, the description that follows generally describes method 201 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order. In some instances, the training method 201 can be used for the training of the trained method used to provide recommendations for field values for fields of the user interface form, as described in relation to method 200 of FIG. 2A.

At 214, initial tabular training data for imputing data for a tabular data object defined for a user interface form of an application is obtained. The tabular data object can be a table or other tabular data form that can be stored at a data storage and be associated with an application. For example, the tabular data object can be associated with a user interface form for obtaining data through the application. For example, the obtaining of data through the user interface form can be associated with obtaining data for generating a new row of data to be stored in the data storage at the tabular data object. The initial tabular training data can include rows of data collected from entries for the user interface form done by users of the application. In some instances, the initial tabular training data can be obtained by invoking data from the data storage associated with the application and relevant for stored data objects for the user interface form.

In some instances, each row of the initial tabular training data includes input field values for the fields of the user interface form stored for the user interface form of the application at a data storage. In some instances, the generation of the noisy tabular training data relies on a second trained model that include application-specific masking rules. The application-specific masking rules can be applied to the initial tabular training data to up-sample the initial tabular data to generate the noisy tabular training data by using data from the noise tabular training data as the predictor. Based on using the second trained model, a respective number of masked copies generated per row of the initial tabular training data can be generated. The respective number of masked copies differs between two rows of data in the initial tabular training data.

At 216, noisy tabular training data is generated by invoking a second trained model over the initial tabular training data. The generation of noisy tabular training data includes up-sampling the initial tabular data according to learned application-specific masking rules defined as part of the second trained model. The application-specific masking rules can be generated for the user interface form of the application so that the noisy data is created in accordance with an understanding of patterns and inferred rules for entering data in the user interface form.

In some instances, the generation of the noisy tabular training data can be performed based on operations 218, 220, and 220.

At 218, interaction data collected in relation to user interactions for filling in data in the fields of the user interface form is obtained. The interaction data includes an order of interactions with fields and data entries. The interaction data includes respective position of the fields on the user interface. In some instances, when users interact with a user interface form, data can be collected for their interaction and input of data in various fields. Also, location of the fields can be provided as part of the information for the fields.

At 220, patterns for filling in data in the user interface form can be identified by analyzing the obtained interaction data. For example, it can be inferred from past historical data, that users first fill in fields on the left upper corner of a user interface, and do not randomly include field values in a user interaction form but rather follow a particular order (e.g., a pattern of filling-in data). An example pattern can be filling in data from top to bottom from left side top section towards right side down section on the user interface.

At 222, the noisy tabular training data is created by generating a set of masked copies per row of the initial tabular training data to be included in the noisy tabular training data.

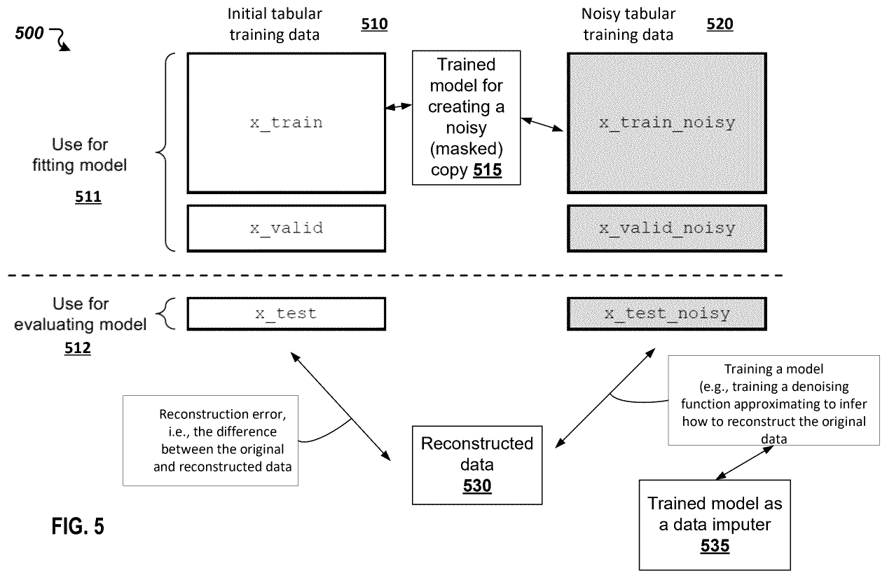

As such, for one row of the initial tabular training data, several copies of that row can be created, where portions of fields from the row can be masked to create the noisy data. For example, the noisy data generation can be performed as described in relation to FIG. 5, and the noisy data can be used to infer a reconstructed data set for a given row, so that the training model can learn to reconstruct tabular data (such as data to be included in a user interface form) based on noisy data (e.g., user interface forms that only include one or more fields that are filled in with data). The inference of the data values for fields in the user interface form can be performed in an iterative manner, as described in relation to FIG. 2A.

The noisy tabular training data generation at 216 can be performed based on the second trained model that can learn patterns for entering data and determine which fields of the user interface form are to be masked more often than other, for example, based on analyzing how fields are filled in at the obtained initial tabular training data.

At 224, the first model is trained by inputting the generated noisy tabular training data as a predictor and by applying denoising techniques to output predicted field values for field of the user interface form.

FIG. 3A is a block diagram illustrating an example user interface form 300 provided for user interaction and input of field values at one or more fields, according to an implementation of the present disclosure. The example user interface form 300 is a form provided as part of an application for generating sales orders. The user interface form 300 implements “smart” logic for recommending data entries in the form while a user is entering their input, in form of recommendations in accordance with implementations of the present disclosure. For example, the user interface form 300 can support providing of data imputation based on a trained model in a similar manner as described in relation to FIG. 2A. the model that can be used to predict values to be imputed in the user interface form 300 can be trained in accordance with the method 201 of FIG. 2B.

In some instances, the user interface form 300 can be provided on a user interface for a display device of a user, where the user interface can be provided by an application such as a sales application, when requested to create a new sales order. The sales orders generated through the user interface form 300 can be stored in a tabular data object at a data storage, such as a database. The user interface form 300 can receive user input and can provide recommendation for imputing tabular data in the user interface form 300 so that upon completion of the sales order creation, the data as provided in the user interface form 300 can be stored as a row in a tabular data object defined for the sales order user interface form 300.

The user interface form 300 includes a data field that is “Sold-to Party” 305 field, where a user can provide input to initiate the creation of a sales order. For example, some fields that are part of the user interface form 300 can be automatically populated upon initiation of creation of a sales order, such as a requested delivery date, or a document date. the field values for such fields can be determined automatically based on preconfigured rules. In the example of the requested delivery date and document date field, a rule can be defined to input a current date of creation of the sales order as the field value. The user interface form 300 can include other data fields that are empty, as shown on FIG. 3A, which can be filled in with values based on user interactions. Such user input for data field can trigger invocation of a trained method, as described in relation to FIG. 2A, to support the filling in of the sales order and to predict values for fields for which no input was provided as recommendations for the entries that can be confirmed or modified by a user filling in the form 300.

FIG. 3B is a block diagram illustrating an example user interface form 301 for user interaction that implements logic for automatic data imputation based on a trained model, according to an implementation of the present disclosure. The example user interface form 301 can be an updated version of the user interface form 300 that is generated upon input of data by a user to fill in the Sold-to Party 310 field with a field value, such as “Intl. Constructions Ltd.”. In that example, when the user had entered the field value for the Sold-to Party 310, a trained model can be automatically invoked to predict values for one or more other user interface fields of the user interface form 300 based on the first field value for the first field and to provide those predicted values as recommendations for values in the user interface form 301. In the example of the user interface form 301, recommendations based on predicted values for fields Customer Group 315, Shipping Conditions, and Ship-to Party 325 are provided for fields part of the order data section of the user interface form 301. In some cases, other fields of the user interface form 301 can be filled in with recommendations based on predicted values as output by the trained model. The recommended values as provided on the user interface form 301 can be highlighted in a particular color, marked, or otherwise annotated to indicate to the user that such fields are automatically input as recommendations and are not user input data.

FIG. 4A is a block diagram illustrating an example user interface form 301 provided for user interaction and modification of a field value provided as a recommendation to a field 325 in the user interface form 301 by invoking a trained model, according to an implementation of the present disclosure. In some instances, a user 410 can continue interacting with the user interface form 301 of FIG. 3B that is populated with recommended values. The user 410 can select (e.g., by performing a mouse click or other operation) a field including a recommended field value, such as the field “Ship-to Party” 325 with the value Intl. Constructions Ltd as a recommendation value. Upon selection of the field “Ship-to Party” 325 with the provided value Intl. Constructions Ltd as a recommendation value, a user interface element 420 can be provided for display on the user interface. The user interface element 420 can be a user interface element including options for values for the Ship-to Party 325 field. In some instances, the user 410 can select another field value, different from the selected field value that is “Int. Constructions Ltd.” For example, the user can select another recommended field value from the list of recommendations 421 that includes the recommended “Intl. Constructions Ltd” value (that is associated with city Hinckley) and instead select the store that is in Durango, that is in Mexico. That would be value “Intl. Constructions Ltd—Store 3” as a value selected by the user 410. In this way, the user 410 would provide input (such as the second input received at operation 208 of FIG. 2A) to modify a respective predicted (and recommended) field data value for the field “Ship-to Party” 325.

FIG. 4B is a block diagram illustrating an example user interface form 400 updated with one or more recommendations for one or more fields of the user interface form based on received user input to modify a previously recommended field value of the user interface form, according to an implementation of the present disclosure. In some instances, the example user interface form 400 includes the modification of the field value for the “Ship-to Party” 325 field into the value “Intl. Constructions Ltd—Store 3” as described in relation to FIG. 4A. Based on selecting the different value, the address field 470 is automatically populated. The population of the address field 470 is based on a defined value per the selected “Ship to Party” selection. As such, in some cases, inputting field values, or modifying field values as recommended by the trained model used to impute the data in the user interface form, as discussed throughout the present disclosure, can result in automatically filling in with field values that are populated based on predefined rules and are not a recommendation that can be modified, and/or may not require a confirmation. In some instances, the inputting of field value or modifying field values can additionally or alternatively be associated with triggering a new invocation of the trained model and being provided with further recommendations for field values for other fields part of the user interface form 400. For example, based on the input modification for the “Ship-to Party” 325 field as discussed in relation to FIG. 4A, and as displayed on FIG. 4B, a set of recommended field values are provided on the user interface form 400 at the advanced data 440 section of the form. In some cases, such recommended field values can be at any section of the form, and the advanced data 440 section as including new field values as recommendations is only used as an example without limiting other options for other fields being provided with recommended values. The recommended values at the advanced data 440 can be generated based on invoking of the trained model upon receiving the interaction of the user for modifying the value at the “Ship-to Party” 325 field.

In some instances, the recommended field value for the “Ship-to Party” 325 as shown on FIG. 4A may be confirmed rather than modified. Upon confirmation of the recommended value for the “Ship-to Party” 325 field, one or more field values in the user interface form 400 can be updated, where those field values may be field values that have not yet been provided with values (either recommended or based on user input). In some instances, upon confirmation of one recommended value, the invocation of the training model can lead to a prediction that differs from a prediction previously provided based on a smaller set of inputted field values used for the prediction.

FIG. 5 is a block diagram illustrating an example method 500 for training a model for tabular data imputation based on denoising techniques, according to an implementation of the present disclosure.

In some instances, a method for leveraging the concept of denoising of noisy data created based on real data generated for data objects created through a user interface form can be used to construct (or train) a machine learning model that can be used as a tabular data imputer. In some instances, a model can be trained to reconstruct an original (or clean) copy of training data (e.g., data collected from historically generated objects through the user interface form and/or otherwise) based on a noisy copy of the same training data.

The example method 500 is executed in the context of training a model that predicts tabular data that is provided through a user interface on a user interface form as recommendations for fill-in data for data fields during the process of filling in the user interface form by a user, as described throughout the present disclosure and for example at FIG. 2A.

In some instances, a model for data imputation 535 can be trained by using training data that is noisy tabular training data 520 as a predictor to infer reconstructed data 530 that is a prediction for the original data, i.e., the initial tabular training data 510 used to generate the “noisy” or masked data, i.e., the noisy tabular training data 520 based on an initial training data set 510. In some instances, the initial tabular training data 510 can be substantially the same as the obtained initial tabular training data 510, at operation 214 of FIG. 2B. The initial tabular training data 510 be used as a starting step to generate the noisy tabular training data 520 based on a trained model 515 (that is the second model as described in relation to FIGS. 2A and 2B). The trained model 515 is a model that determines how to mask data from the initial tabular training data to up-sample the data without preparing masked copies covering all possible masking combinations but rather masking in a pattern consistent with the inputting of data through a user interface form to be stored as tabular data.

The noisy tabular training data 520 can be used to train the model 535 by training a denoising function to approximate values for fields in a user interface form, based on input including a “noisy” record of field values provided in a row of the noisy tabular training data 520. The approximated values for fields match an approximation of missing data values in data objects from the noisy tabular training data 520 that are generated based on the masking according to the trained model 515. In some instances, to perform the training, the training data, including the initial tabular training data 510 and the noisy tabular training data 520 can be divided into data 511 to be used for fitting the model 535, and data 512 to be used for evaluating the model 535.

Generating noisy tabular training data 520 in general can be performed by different masking techniques including exhaustive, random, or domain-driven masking as to simulate noise in the initial tabular training data. In practice, exhaustive masking is may be too resource intensive and expensive compared to the other techniques. Random masking, while simpler and cheaper to implement, may not be associated with high accuracy in prediction and may show poor performance compared to other techniques. Domain-driven masking can involve combining use case specific quantitative and qualitative analysis to derive a model (a machine learning model) such as the model 515 that can output an optimal amount of masking (random or otherwise) that can be applied to each column or row in the initial tabular training data. In some instances, the model 515 can be trained to consider factors associated with the specifics of the data, for example, specific of the user interface form at the application and constraints, rules or definition of fields in the user interface form that can have an impact on the type of values that can be collected. In some instances, the model 515 can be trained to consider factors such as cardinality of a column in the tabular data (i.e., the number of unique different values that may occur in that column) and the user interaction order (i.e., the order in which values in a row of training data might appear to a user in the user interface form).

In some instances, the trained model 535 can be trained based on training data that is generated using denoising algorithms. The denoising algorithms may be associated with higher accuracy when they are used in consideration of more training data. To improve the accuracy of the denoising and training the model 535 as a data imputer, domain-driven up-sampling can be performed to generate noisy tabular training data 520 as an up-sampled set of data created based on existing rows in the initial tabular training data 510 by applying asking on those rows. In such manner, multiple rows in the noisy tabular training data 520 can be generated as masked copies of a single row from the initial tabular training data 510. The up-sampling can be performed to generate different amount of data for the noisy tabular training data 520, since different up-sampling techniques can be used (e.g., up-sample each row by a fixed amount or using a trained model, such as the model 515 to derive an optimal number of up-sample copies). The model 515 can be trained to generate the noisy tabular training data 520 by up-sampling that is inferred based on factors such as the number of rows in the initial tabular training data 510, the number of columns in the initial tabular training data 510, and/or the cardinality of one or more of the columns in the initial tabular training data 510. In some instances, the trained model 515 can use data for the order of interaction with fields (and respective objects in rows in the tabular data) to determine the up-sampling done for the initial tabular training data 510.

In some instances, it may be determined that users of an application or a user interface form (e.g., considered as application or form domains as domains specifically used for the training) first fill in those fields in a user interface form that are displayed in the top-left corner of a user interface. Based on such determination, the up-sampling can be applied by leaving more of the data objects in a row of the initial tabular training data corresponding to such fields displayed in the top-left corner of the user interface as unmasked more often compared to masking data objects in rows that are associated with field that are displayed in the right-down corner of a user interface (as fields being filled in last). In some instances, the trained model 515 can be trained to generate up-sampling that reflect behavior tracking of user interaction (e.g., click stream, data entry, navigation within sections, etc.).

In some instances, the trained model 515 can be derived by optimizing the masking function that is to be applied to the initial tabular training data 510. In some instances, a basic type of a masking strategy/function can be selected and optimized. For example, the basic type of masking can be selected to be random masking using a Bernoulli distribution. A masking function can have one or more parameters that can be set to configure the behavior of the masking function. In the example of the random masking using a Bernoulli distribution, the behavior of a Bernoulli function can be controlled by a single parameter p that specifies a probability of a successful event. In some instances, the masking function parameters can be iteratively modified where at each iteration relevant model performance metrics (e.g., accuracy, precision, recall) can be recorded. The performance metrics can be monitored during the modification of the parameters to fine-tune the parameters and optimize according to one or more metric. In some instances, if the order in which fields are displayed and/or filled in by a user in the user interface form are to be considered for the masking, different masking function parameter values per field can be used for the modifications to monitor the performance. For example, in the use case of a user interface form that is for sales order creation (e.g., as discussed in relation to FIGS. 3A, 3B, 4A, 4B, and 4C), and if a Bernoulli masking function is to be optimized, a value for a field such as the field “Customer Group” can be determined to be masked with a particular parameter (e.g., p=0.5) and another field such as “Shipping Conditions” to be masked with another parameter (e.g., p=0.1). The used parameters for the masking can be inferred from the type of the tabular user interface form, the masking algorithm to be optimized, and/or the user interaction with fields at different locations as presented on the user interface. Based on the iterative evaluation of the performance based on different masking of fields, a data set of model performance metrics can be generated per field of the tabular data (or column in the tabular data as a table). The trained model 515 can be further optimized and trained on such performance metric data to identify correlation between choices of masking parameter values and model performance metrics to identify optimal parameter values (or optimal masking function configuration) for use in a given use case of training a model such as the model 535 that is a tabular data imputer.

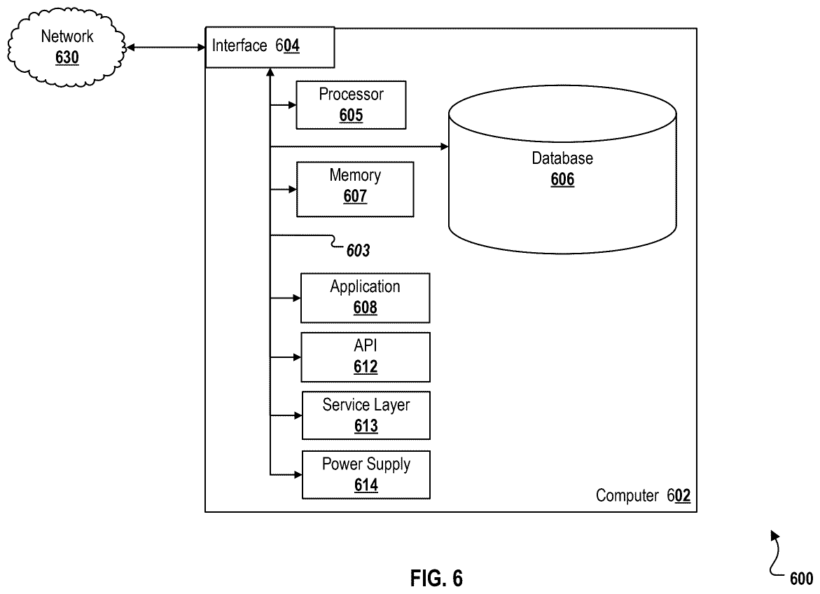

FIG. 6 is a block diagram illustrating an example of a computer-implemented System 600 used to provide computational functionalities associated with described algorithms, methods, functions, processes, flows, and procedures, according to an implementation of the present disclosure. In the illustrated implementation, computer-implemented system 600 includes a Computer 602 and a Network 630.

The illustrated Computer 602 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 602 can include an input device, such as a keypad, keyboard, or touch screen, or a combination of input devices that can accept user information, and an output device that conveys information associated with the operation of the Computer 602, including digital data, visual, audio, another type of information, or a combination of types of information, on a graphical-type user interface (UI) (or GUI) or other UI.

The Computer 602 can serve in a role in a distributed computing system as, for example, a client, network component, a server, or a database or another persistency, or a combination of roles for performing the subject matter described in the present disclosure. The illustrated Computer 602 is communicably coupled with a Network 630. In some implementations, one or more components of the Computer 602 can be configured to operate within an environment, or a combination of environments, including cloud-computing, local, or global.

At a high level, the Computer 602 is an electronic computing device operable to receive, transmit, process, store, or manage data and information associated with the described subject matter. According to some implementations, the Computer 602 can also include or be communicably coupled with a server, such as an application server, e-mail server, web server, caching server, or streaming data server, or a combination of servers.

The Computer 602 can receive requests over Network 630 (for example, from a client software application executing on another Computer 602) and respond to the received requests by processing the received requests using a software application or a combination of software applications. In addition, requests can also be sent to the Computer 602 from internal users (for example, from a command console or by another internal access method), external or third-parties, or other entities, individuals, systems, or computers.

Each of the components of the Computer 602 can communicate using a System Bus 603. In some implementations, any or all of the components of the Computer 602, including hardware, software, or a combination of hardware and software, can interface over the System Bus 603 using an application programming interface (API) 612, a Service Layer 613, or a combination of the API 612 and Service Layer 613. The API 612 can include specifications for routines, data structures, and object classes. The API 612 can be either computer-language independent or dependent and refer to a complete interface, a single function, or even a set of APIs. The Service Layer 613 provides software services to the Computer 602 or other components (whether illustrated or not) that are communicably coupled to the Computer 602. The functionality of the Computer 602 can be accessible for all service consumers using the Service Layer 613. Software services, such as those provided by the Service Layer 613, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 602, alternative implementations can illustrate the API 612 or the Service Layer 613 as stand-alone components in relation to other components of the Computer 602 or other components (whether illustrated or not) that are communicably coupled to the Computer 602. Moreover, any or all parts of the API 612 or the Service Layer 613 can be implemented as a child or a sub-module of another software module, enterprise application, or hardware module without departing from the scope of the present disclosure.

The Computer 602 includes an Interface 604. Although illustrated as a single Interface 604, two or more Interfaces 604 can be used according to particular needs, desires, or particular implementations of the Computer 602. The Interface 604 is used by the Computer 602 for communicating with another computing system (whether illustrated or not) that is communicatively linked to the Network 630 in a distributed environment. Generally, the Interface 604 is operable to communicate with the Network 630 and includes logic encoded in software, hardware, or a combination of software and hardware. More specifically, the Interface 604 can include software supporting one or more communication protocols associated with communications such that the Network 630 or hardware of Interface 604 is operable to communicate physical signals within and outside of the illustrated Computer 602.

The Computer 602 includes a Processor 605. Although illustrated as a single Processor 605, two or more Processors 605 can be used according to particular needs, desires, or particular implementations of the Computer 602. Generally, the Processor 605 executes instructions and manipulates data to perform the operations of the Computer 602 and any algorithms, methods, functions, processes, flows, and procedures as described in the present disclosure.

The Computer 602 also includes a Database 606 that can hold data for the Computer 602, another component communicatively linked to the Network 630 (whether illustrated or not), or a combination of the Computer 602 and another component. For example, Database 606 can be an in-memory or conventional database storing data consistent with the present disclosure. In some implementations, Database 606 can be a combination of two or more different database types (for example, a hybrid in-memory and conventional database) according to particular needs, desires, or particular implementations of the Computer 602 and the described functionality. Although illustrated as a single Database 606, two or more databases of similar or differing types can be used according to particular needs, desires, or particular implementations of the Computer 602 and the described functionality. While Database 606 is illustrated as an integral component of the Computer 602, in alternative implementations, Database 606 can be external to the Computer 602. The Database 606 can hold and operate on at least any data type mentioned or any data type consistent with this disclosure.

The Computer 602 also includes a Memory 607 that can hold data for the Computer 602, another component or components communicatively linked to the Network 630 (whether illustrated or not), or a combination of the Computer 602 and another component. Memory 607 can store any data consistent with the present disclosure. In some implementations, Memory 607 can be a combination of two or more different types of memory (for example, a combination of semiconductor and magnetic storage) according to particular needs, desires, or particular implementations of the Computer 602 and the described functionality. Although illustrated as a single Memory 607, two or more Memories 607 or similar or differing types can be used according to particular needs, desires, or particular implementations of the Computer 602 and the described functionality. While Memory 607 is illustrated as an integral component of the Computer 602, in alternative implementations, Memory 607 can be external to the Computer 602.

The Application 608 is an algorithmic software engine providing functionality according to particular needs, desires, or particular implementations of the Computer 602, particularly with respect to functionality described in the present disclosure. For example, Application 608 can serve as one or more components, modules, or applications. Further, although illustrated as a single Application 608, the Application 608 can be implemented as multiple Applications 608 on the Computer 602. In addition, although illustrated as integral to the Computer 602, in alternative implementations, the Application 608 can be external to the Computer 602.

The Computer 602 can also include a Power Supply 614. The Power Supply 614 can include a rechargeable or non-rechargeable battery that can be configured to be either user-or non-user-replaceable. In some implementations, the Power Supply 614 can include power-conversion or management circuits (including recharging, standby, or another power management functionality). In some implementations, the Power Supply 614 can include a power plug to allow the Computer 602 to be plugged into a wall socket or another power source to, for example, power the Computer 602 or recharge a rechargeable battery.

There can be any number of Computers 602 associated with, or external to, a computer system containing Computer 602, each Computer 602 communicating over Network 630. Further, the term “client,” “user,” or other appropriate terminology can be used interchangeably, as appropriate, without departing from the scope of the present disclosure. Moreover, the present disclosure contemplates that many users can use one Computer 602, or that one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near (ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a graphics processing unit (GPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, a GPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Described implementations of the subject matter can include one or more features, alone or in combination.

### EXAMPLES

Although the present application is defined in the attached claims, it should be understood that the present invention can also be (alternatively) defined in accordance with the following examples:

### Machine Learning Algorithms for Tabular Data Imputation

Example 1: A computer-implemented method, the method comprising:
receiving first input data from a user, the first input data including a first field value for a first field on a user interface form provided on a user interface at a display device;
in response to receiving the first input data, invoking a trained model for tabular data imputation to predict values for one or more other user interface fields of the user interface form based on the first field value for the first field;
providing one or more predicted field data values for the one or more other user interface fields on the user interface form based on an output of the trained model as recommendations for the user;
receiving second input data from the user including a second field value for a second field of the one or more other user interface fields, wherein the second input data is confirming or modifying a respective predicted field data value for the second field;
in response to receiving the second field value from the user, automatically invoking the trained model to predict a third field value for a third field of the user interface form based on the received first field value for the first field and the received second field value for the second field; and
providing the third field value for the third field on the user interface form in addition to previously-provided predicted or confirmed field data values for fields of the user interface form.
   Example 2: The method of Example 1, wherein the trained model predicts the third field value for the third field of the user interface form based on only the received first and second input data from the user without using other field data values from the provided one or more predicted field data values as recommendations for the user interface form.
   Example 3: The method of any one of the preceding Examples, wherein, in response to receiving the first field value for the first field and the second field value for the second field from the user, updating a tabular data object stored for the user interface form by updating a first data object and a second data object to store data according to the first field value and the second field value, wherein the first data object corresponds to the first field and the second data object corresponds to the second field.
   Example 4: The method of any one of the preceding Examples, comprising:
in response to receiving fourth input data from the user including a fourth field value for a fourth field of the user interface form, the fourth field being different from the first and second fields, invoking the trained model to predict data for at least one other field of the user interface form based on the first field value, the second field value, and the fourth field value.
   Example 5: The method of any one of the preceding Examples wherein the received second input data from the user for the second field is to modify the respective predicted field data value for the second field as provided as a recommendation to the second field value, and wherein receiving the second input data to modify the respective predicted field data value comprises receiving a selection of a set of options for available field data values for the second field, the set of options for available field data values being configured as predefined options for the second field.
   Example 6: The method of any one of the preceding Examples, wherein the second input data from the user for the second field is to confirm the respective predicted field data value for the second field as provided as a recommendation, and wherein receiving the second input data to confirm the respective predicted field data value comprises receiving a selection of the respective predicted field data value for the second field by the user at the user interface form, wherein automatically invoking the trained model comprises:
invoking the trained model, based on inputting only the first field value and the second field value for respectively the first field and the second field to update at least one of the one or more predicted field data values as previously predicted for user interface fields different from the first field and the second field.
   Example 7: The method of any one of the preceding Examples, wherein the user interface form is associated with a tabular data object stored at a respective storage associated with the user interface form, wherein each data objects of the tabular data object corresponds to a respective user interface field of the user interface form.
   Example 8: The method of Example 7, wherein the trained model is a first trained model that is trained based on denoising techniques applied to noisy tabular training data, wherein the noisy tabular training data is generated for a tabular data object stored at a storage associated with the user interface by using a second model, therein the tabular data object includes data objects corresponding to user interface fields of the user interface form.
   Example 9: The method of Example 8, wherein the method comprises training the first trained model, wherein the training comprises:
obtaining initial tabular training data for the tabular data object; and
   generating the noisy tabular training data for the tabular data object by invoking the second model that is trained over the initial tabular training data, wherein the generated noisy tabular training data is generated by up-sampling the initial tabular training data according to learned masking rule as part of the second model, the learned masking rules to be applied to the initial tabular training data to up-sample the initial tabular training data.
      Example 10: The method of Example 9, wherein the second model is trained to generate a respective number of masked copies per row of data in the initial tabular training data, wherein the respective number of masked copies differs between two rows of data in the initial tabular training data.
      Example 11: The method of Example 9, wherein the training of the first training model further comprises:
obtaining interaction data collected in relation to user interactions for filling in data in fields of the user interface form, wherein the interaction data includes an order of interaction with fields and respective position of the fields on the user interface; and
inferring, by analyzing the obtained interaction data, patterns for filling in data in the user interface form;
wherein generating the noisy tabular training data by invoking the second model comprises:
   generating a set of row copies per row of the initial tabular training data, wherein a row of the tabular training data includes a set of field values, wherein a row of the tabular training data is associated with a single filled-in user interaction form at the user interface.
      Example 12. A system comprising:
one or more processors; and
one or more computer-readable memories coupled to the one or more processors and having instructions stored thereon that are executable by the one or more processors to perform the method of any of Examples 1 to 11.
   Example 13. A non-transitory, computer-readable medium coupled to one or more processors and having instructions stored thereon which, when executed by the one or more processors, cause the one or more processors to perform the method of any of Examples 1 to 11.

### Machine Learning Model for Training Data Generation

Example 1: A computer-implemented method for training a model to perform tabular data imputation, the method comprising:
obtaining initial tabular training data for imputing data for a tabular data object defined for a user interface form of an application, wherein the initial tabular training data includes rows of data collected from entries for the user interface form submitted by users of the application;
generating noisy tabular training data by invoking a second model trained over the initial tabular training data, wherein generating noisy tabular training data comprises up-sampling the initial tabular training data according to learned application-specific masking rules defined as part of the second model, the application-specific masking rules being generated for the user interface form of the application; and
training a first model by inputting the generated noisy tabular training data as a predictor and by applying denoising techniques to output predicted field values for fields of the user interface form.
   Example 2: The method of Example 1, wherein each row of the initial tabular training data includes input field values for the fields of the user interface form stored for the user interface form of the application at a data storage.
   Example 3: The method of any one of the preceding Examples, wherein the application-specific masking rules are applied to the initial tabular training data to up-sample the initial tabular training data to generate the noisy tabular training data by using data from the noise tabular training data as the predictor, wherein, based on using the second model, a respective number of masked copies generated per row of the initial tabular training data is generated, wherein the respective number of masked copies differs between two row of data in the initial tabular training data.
   Example 4: The method of any one of the preceding Examples, wherein generating the noisy tabular training data comprises:
obtaining interaction data collected in relation to user interactions for filling in data in the fields of the user interface form, wherein the interaction data includes an order of interactions with fields and data entries, wherein the interaction data includes respective position of the fields on the user interface form when displayed at a user interface of a display device;
identifying patterns for filling in data in the user interface form by analyzing the obtained interaction data; and
generating a set of masked copies per row of the initial tabular training data to be included in the noisy tabular training data.
   Example 5: The method of any one of the preceding Examples, comprising:
receiving first input data from a user including a first field value for a first field on the user interface form provided on a user interface of the application;
in response to receiving the first input data, invoking the first model to predict values for one or more other user interface fields of the user interface form based on the first field value for the first field, the first model being for tabular data imputation;
providing one or more predicted field data values for the one or more other user interface fields on the user interface form as recommendations for the user;
receiving second input data from the user including a second field value for a second field of the one or more other user interface fields, wherein the second input data is confirming or modifying a respective predicted field data value for the second field;
in response to receiving the second field value from the user, automatically invoking the first model to predict a third field value for a third field of the user interface form based on the first field value received from the user for the first field and the second field for the second field; and
providing the third field value for the third field on the user interface form in additional to previously provided predicted or confirmed field data values for fields of the user interface form.
   Example 6: The method of Example 5, wherein the first model predicts the data for the third field of the user interface form based on only the first and second input data received from the user without using other field data values from the provided one or more predicted field data values as recommendations for the user interface form.
   Example 7: The method of Example 5, comprising:
in response to receiving fourth input data from the user including a fourth field value for a fourth field of the user interface form, the fourth field being different from the first and second fields, invoking the first model to predict data for at least one other field of the user interface form based on the first field value, the second field value, and the fourth field value.
   Example 8: The method of Example 7, wherein the first model is trained based on a denoising techniques applied to noisy tabular training data, wherein the noisy tabular training data is generated for a tabular data object stored at a storage associated with the user interface by using the second model, therein the tabular data object includes data objects corresponding to user interface fields of the user interface form.
   Example 9. A system comprising:
one or more processors; and
one or more computer-readable memories coupled to the one or more processors and having instructions stored thereon that are executable by the one or more processors to perform the method of any of Examples 1 to 8.
   Example 10. A non-transitory, computer-readable medium coupled to one or more processors and having instructions stored thereon which, when executed by the one or more processors, cause the one or more processors to perform the method of any of Examples 1 to 8.

What is claimed is:

1. A computer-implemented method for training a model to perform tabular data imputation, the method comprising:
obtaining initial tabular training data for imputing data for a tabular data object defined for a user interface form of an application, wherein the initial tabular training data includes rows of data collected from entries for the user interface form submitted by users of the application;
generating noisy tabular training data by invoking a second model trained over the initial tabular training data, wherein generating noisy tabular training data comprises up-sampling the initial tabular training data according to learned application-specific masking rules defined as part of the second model, the application-specific masking rules being generated for the user interface form of the application; and
training a first model by inputting the generated noisy tabular training data as a predictor and by applying denoising techniques to output predicted field values for fields of the user interface form.

2. The method of claim 1, wherein each row of the initial tabular training data includes input field values for the fields of the user interface form stored for the user interface form of the application at a data storage.

3. The method of claim 1, wherein the application-specific masking rules are applied to the initial tabular training data to up-sample the initial tabular training data to generate the noisy tabular training data by using data from the noise tabular training data as the predictor, wherein, based on using the second model, a respective number of masked copies generated per row of the initial tabular training data is generated, wherein the respective number of masked copies differs between two row of data in the initial tabular training data.

4. The method of claim 1, wherein generating the noisy tabular training data comprises:
obtaining interaction data collected in relation to user interactions for filling in data in the fields of the user interface form, wherein the interaction data includes an order of interactions with fields and data entries, wherein the interaction data includes respective position of the fields on the user interface form when displayed at a user interface of a display device;
identifying patterns for filling in data in the user interface form by analyzing the obtained interaction data; and
generating a set of masked copies per row of the initial tabular training data to be included in the noisy tabular training data.

5. The method of claim 1, comprising:
receiving first input data from a user including a first field value for a first field on the user interface form provided on a user interface of the application;
in response to receiving the first input data, invoking the first model to predict values for one or more other user interface fields of the user interface form based on the first field value for the first field, the first model being for tabular data imputation;
providing one or more predicted field data values for the one or more other user interface fields on the user interface form as recommendations for the user;
receiving second input data from the user including a second field value for a second field of the one or more other user interface fields, wherein the second input data is confirming or modifying a respective predicted field data value for the second field;
in response to receiving the second field value from the user, automatically invoking the first model to predict a third field value for a third field of the user interface form based on the first field value received from the user for the first field and the second field for the second field; and

6. The method of claim 5, wherein the first model predicts the data for the third field of the user interface form based on only the first and second input data received from the user without using other field data values from the provided one or more predicted field data values as recommendations for the user interface form.

7. The method of claim 5, comprising:
in response to receiving fourth input data from the user including a fourth field value for a fourth field of the user interface form, the fourth field being different from the first and second fields, invoking the first model to predict data for at least one other field of the user interface form based on the first field value, the second field value, and the fourth field value.

8. The method of claim 7, wherein the first model is trained based on a denoising techniques applied to noisy tabular training data, wherein the noisy tabular training data is generated for a tabular data object stored at a storage associated with the user interface by using the second model, therein the tabular data object includes data objects corresponding to user interface fields of the user interface form.

9. A non-transitory, computer-readable medium storing one or more instructions executable by a computer system to perform one or more operations comprising:
obtaining initial tabular training data for imputing data for a tabular data object defined for a user interface form of an application, wherein the initial tabular training data includes rows of data collected from entries for the user interface form submitted by users of the application;
generating noisy tabular training data by invoking a second model trained over the initial tabular training data, wherein generating noisy tabular training data comprises up-sampling the initial tabular training data according to learned application-specific masking rules defined as part of the second model, the application-specific masking rules being generated for the user interface form of the application; and
training a first model by inputting the generated noisy tabular training data as a predictor and by applying denoising techniques to output predicted field values for fields of the user interface form.

10. The computer-readable medium of claim 9, wherein each row of the initial tabular training data includes input field values for the fields of the user interface form stored for the user interface form of the application at a data storage.

11. The computer-readable medium of claim 9, wherein the application-specific masking rules are applied to the initial tabular training data to up-sample the initial tabular training data to generate the noisy tabular training data by using data from the noise tabular training data as the predictor, wherein, based on using the second model, a respective number of masked copies generated per row of the initial tabular training data is generated, wherein the respective number of masked copies differs between two row of data in the initial tabular training data.

12. The computer-readable medium of claim 9, wherein generating the noisy tabular training data comprises:
obtaining interaction data collected in relation to user interactions for filling in data in the fields of the user interface form, wherein the interaction data includes an order of interactions with fields and data entries, wherein the interaction data includes respective position of the fields on the user interface form when displayed at a user interface of a display device;
identifying patterns for filling in data in the user interface form by analyzing the obtained interaction data; and
generating a set of masked copies per row of the initial tabular training data to be included in the noisy tabular training data.

13. The computer-readable medium of claim 9, wherein the operations comprise:
receiving first input data from a user including a first field value for a first field on the user interface form provided on a user interface of the application;
in response to receiving the first input data, invoking the first model to predict values for one or more other user interface fields of the user interface form based on the first field value for the first field, the first model being for tabular data imputation;
providing one or more predicted field data values for the one or more other user interface fields on the user interface form as recommendations for the user;
receiving second input data from the user including a second field value for a second field of the one or more other user interface fields, wherein the second input data is confirming or modifying a respective predicted field data value for the second field;
in response to receiving the second field value from the user, automatically invoking the first model to predict a third field value for a third field of the user interface form based on the first field value received from the user for the first field and the second field for the second field; and
providing the third field value for the third field on the user interface form in additional to previously provided predicted or confirmed field data values for fields of the user interface form.

14. The computer-readable medium of claim 13, wherein the first model predicts the data for the third field of the user interface form based on only the first and second input data received from the user without using other field data values from the provided one or more predicted field data values as recommendations for the user interface form.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
obtaining initial tabular training data for imputing data for a tabular data object defined for a user interface form of an application, wherein the initial tabular training data includes rows of data collected from entries for the user interface form submitted by users of the application;
generating noisy tabular training data by invoking a second model trained over the initial tabular training data, wherein generating noisy tabular training data comprises up-sampling the initial tabular training data according to learned application-specific masking rules defined as part of the second model, the application-specific masking rules being generated for the user interface form of the application; and
training a first model by inputting the generated noisy tabular training data as a predictor and by applying denoising techniques to output predicted field values for fields of the user interface form.

16. The system of claim 15, wherein each row of the initial tabular training data includes input field values for the fields of the user interface form stored for the user interface form of the application at a data storage.

17. The system of claim 15, wherein the application-specific masking rules are applied to the initial tabular training data to up-sample the initial tabular training data to generate the noisy tabular training data by using data from the noise tabular training data as the predictor, wherein, based on using the second model, a respective number of masked copies generated per row of the initial tabular training data is generated, wherein the respective number of masked copies differs between two row of data in the initial tabular training data.

18. The system of claim 15, wherein generating the noisy tabular training data comprises:
obtaining interaction data collected in relation to user interactions for filling in data in the fields of the user interface form, wherein the interaction data includes an order of interactions with fields and data entries, wherein the interaction data includes respective position of the fields on the user interface form when displayed at a user interface of a display device;
identifying patterns for filling in data in the user interface form by analyzing the obtained interaction data; and
generating a set of masked copies per row of the initial tabular training data to be included in the noisy tabular training data.

19. The system of claim 15, comprising:
receiving first input data from a user including a first field value for a first field on the user interface form provided on a user interface of the application;
in response to receiving the first input data, invoking the first model to predict values for one or more other user interface fields of the user interface form based on the first field value for the first field, the first model being for tabular data imputation;
providing one or more predicted field data values for the one or more other user interface fields on the user interface form as recommendations for the user;
receiving second input data from the user including a second field value for a second field of the one or more other user interface fields, wherein the second input data is confirming or modifying a respective predicted field data value for the second field;
in response to receiving the second field value from the user, automatically invoking the first model to predict a third field value for a third field of the user interface form based on the first field value received from the user for the first field and the second field for the second field; and

20. The system of claim 19, wherein the first model predicts the data for the third field of the user interface form based on only the first and second input data received from the user without using other field data values from the provided one or more predicted field data values as recommendations for the user interface form.
